(19) United States
(12) Patent Application Publication
(10) Pub. No.: US 2005/0154934 A1
(43) Pub. Date: Jul. 14, 2005

(54) Apparatus and method for controlling power save mode of an electronic appliance

(75) Inventor: Hyuck Kim, Seongnam-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/025,050

(22) Filed: Dec. 30, 2004

(30) Foreign Application Priority Data
Jan. 9, 2004 (KR) 2004-1418

(51) Int. Cl. G06F 1/26

(52) U.S. Cl. 713/323

(57) ABSTRACT

An apparatus and method for controlling a power save mode of an electronic appliance, such as a printer, a photocopier, a multifunctional device, or an electronic oven, are provided. The apparatus comprises a power save mode control unit, which prevents a power save mode from being set in the electronic appliance during a predetermined time range. The apparatus may further comprise a no-power save mode setting time range setting unit, which sets the predetermined time range so that the power save mode can be prevented from being set in the electronic appliance.

### CROSS-REFERENCE TO RELATED APPLICATIONS

This application claims the benefit under 35 U.S.C. §119(a) of Korean Patent Application No. 10-2004-0001418, filed on Jan. 9, 2004, in the Korean Intellectual Property Office, the entire disclosure of which is hereby incorporated herein by reference.

### BACKGROUND OF THE INVENTION

1. Field of the Invention

The present invention relates to an apparatus and method for controlling a power save mode of an electronic appliance, such as a printer, a photocopier, or an electronic oven. More particularly, the present invention relates to an apparatus and method for controlling a power save mode of an electronic appliance, which can maximize user convenience when the electronic appliance is frequently used, and can prevent the waste of electricity when the electronic appliance is not used by setting a power save mode in the electronic appliance at all times when the electronic appliance is not frequently used.

2. Description of the Related Art

In general, a conventional power supply controlling apparatus for an electronic appliance controls power supplied to an electronic appliance for enabling the electronic appliance to perform its operations. However, if power is continuously supplied to the electronic appliance even after the electronic appliance stops performing its operations, the electronic appliance may waste energy. Therefore, the conventional power supply controlling apparatus adopts a power save mode, in which the amount of energy supplied to the electronic appliance is gradually reduced after a predetermined period of time after the electronic appliance stops performing its operation, and is recovered when the electronic appliance resumes operation. Such a power save mode method is disclosed in Korean Patent Laid-open Publication No. 1999-033241 (Application No. 10-1997-544546).

Even though the conventional power supply controlling apparatus can reduce the power consumption of the electronic appliance to some extent, it spends a considerable amount of time warming the electronic appliance up, for instance, when switching the current mode of the electronic appliance from a power save mode to an operation mode or vice versa.

For example, a fixing unit for a color laser printer, which fixes a toner image transferred onto a recording medium, such as printing paper or the like, operates at a high temperature, and it generally takes a long time to heat the fixing unit or cool it down. Accordingly, it also takes a long time to switch the current mode of the color laser printer from a power save mode to an operation mode, to allow the toner image to be fixed onto the recording medium. Therefore, a user has to wait for a long time period until the current mode of the color laser printer is switched from the power save mode to the operation mode.

For example, a high-speed photocopier spends more time than a low-speed photocopier heating or cooling a fuse roll or a heater roll. Therefore, the user still has to wait for a long time period for the current mode to be switched from a power save mode to an operation mode, before starting to copy.

A conventional method of controlling the power save mode of a color laser printer will now be described more fully with reference to FIG. 1.

Referring to FIG. 1, a user determines whether and when to use a power save function in operation S2. If the user sets the power save function in a printer, the controller calculates how much time has passed since the last print request and determines whether more than a predetermined amount of time set by the user has passed since the last print request (S4). If more than the predetermined amount of time set by the user has passed since the last print request, the printer controller executes the power save function (S6), thereby switching the current mode of the printer into a power save mode. Thereafter, if the conditions for an operation mode are met due to signals input by the user or by other external inputs, the current mode of the printer is switched from the power save mode to the operation mode. When the current mode of the printer is switched from the power save mode to the operation mode, the printer performs a preheating operation or a warm-up operation.

A conventional method of controlling the power save mode of a high-speed photocopier will now be described more fully with reference to FIGS. 2 and 3.

Referring to FIG. 2, a high-speed photocopier includes a temperature sensor 11, which detects the temperature of a fuse roll 14, a power supply controller 12, which generates a power supply control signal for controlling the temperature of the fuse roll 14 depending on the current state of the high-speed photocopier, and a power supply 13, which supplies power to the fuse roll 14 in response to the power supply control signal output from the power supply controller 12.

The power save operation of the photocopier of FIG. 2 will now be described more fully with reference to FIG. 3.

Referring to FIG. 3, the power supply controller 12 checks whether printing has stopped. If printing is stopped, the power supply controller 12 measures the time that has passed since printing stopped and checks whether more than a predetermined amount of time has passed. If more than the predetermined amount of time has passed since printing was stopped, the power supply controller 12 applies a power supply control signal for cooling down the fuse roll 14 to a predetermined temperature set for a power save mode to the power supply 13. Then, the power supply 13 switches off the power supplied to the fuse roll 14 in response to the power supply control signal so that the fuse roll 14 can be cooled down to the predetermined temperature set for the power save mode. In addition, the power supply 13 controls the power supplied to the fuse roll 14 so that the fuse roll 14 can be maintained at the predetermined temperature set for the power save mode until a predetermined operation mode signal is generated.

If the power supply controller 12 recognizes that it is necessary to switch the current mode of the printer from the power save mode to the operation mode, it controls the power supply 13 so that the power supply 13 can continuously supply power to the fuse roll 14 until the fuse roll 14 reaches a predetermined temperature at which the printer can perform printing.

However, it takes time for the fuse roll 14 to increase its temperature from the lower predetermined temperature set for the power save mode to the predetermined temperature set for the operation mode, which means that it takes time for the fuse roll 14 to warm up, and thus, the user has to wait a long time period for the high-speed photocopier to leave the power save mode and be ready to perform printing.

As described above, the conventional power supply controlling apparatus for an electronic device spends a long time period switching the current mode of the electronic device from a power save mode to an operation mode causing inconvenience for the users. In other words, once a power save function is set in the electronic appliance, the electronic appliance indiscriminately enters the power save mode as soon as a few conditions for the power save mode are met causing tremendous inconvenience for users especially during the time when the electronic appliance is frequently used.

Accordingly, a power supply controlling apparatus is needed that allows a user to set additional conditions, wherein the additional conditions prevent an appliance that is not frequently used from entering a power save mode.

### SUMMARY OF THE INVENTION

The present invention provides an apparatus and method of controlling a power save mode of an electronic appliance, which can maximize the convenience for users when the electronic appliance is frequently used, and can prevent electricity from being wasted when the electronic appliance is not used by setting a power save mode in the electronic appliance at all times when the electronic appliance is not frequently used.

According to an aspect of the present invention, there is provided an apparatus for controlling a power save mode of an electronic appliance that supports a power save mode function. The apparatus comprises a power save mode control unit, which prevents a power save mode from being set in the electronic appliance during a predetermined time range.

The apparatus may further comprises a no-power save mode setting time range setting unit, which sets the predetermined time range so that the power save mode can be prevented from being set in the electronic appliance.

The no-power save mode setting time range setting unit may be located in the operating panel equipment (OPE) of the electronic appliance, or in a predetermined host terminal which is connected to the electronic appliance so as to communicate with the electronic appliance in a wired or wireless manner.

The predetermined time range may be set as a default when manufacturing the electronic appliance.

Outside the predetermined time range, the power save mode control unit may execute the power save mode according to the conditions of the power save mode.

According to another aspect of the present invention, there is provided a method of controlling a power save mode of an electronic appliance that supports a power save mode function. The method may involve the operation or step of preventing a power save mode from being set in the electronic appliance during a predetermined time range.

The method may further involve the operation or step of setting the predetermined time range so that the power save mode can be prevented from being set in the electronic appliance.

Outside the predetermined time range, the power save mode is executed according to conditions of the power save mode.

### BRIEF DESCRIPTION OF THE DRAWINGS

The above and other features and advantages of the present invention will become more apparent by describing in detail exemplary embodiments thereof with reference to the attached drawings in which:

FIG. 1 is a flowchart illustrating a conventional method of controlling a power save mode of an electronic appliance;

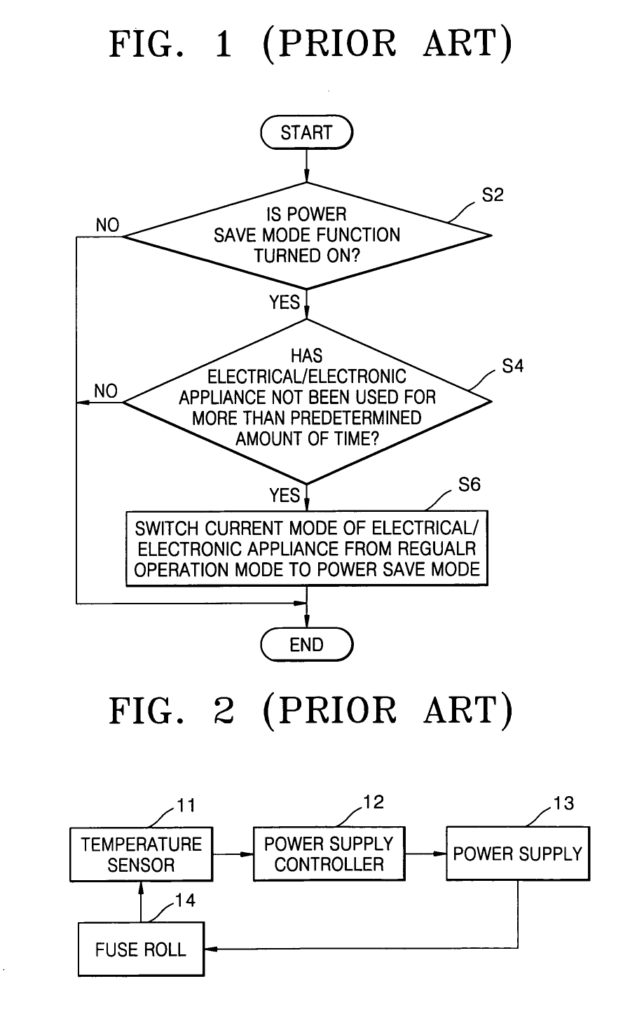

FIG. 2 is a block diagram illustrating a conventional apparatus for controlling a power save mode of an electronic appliance;

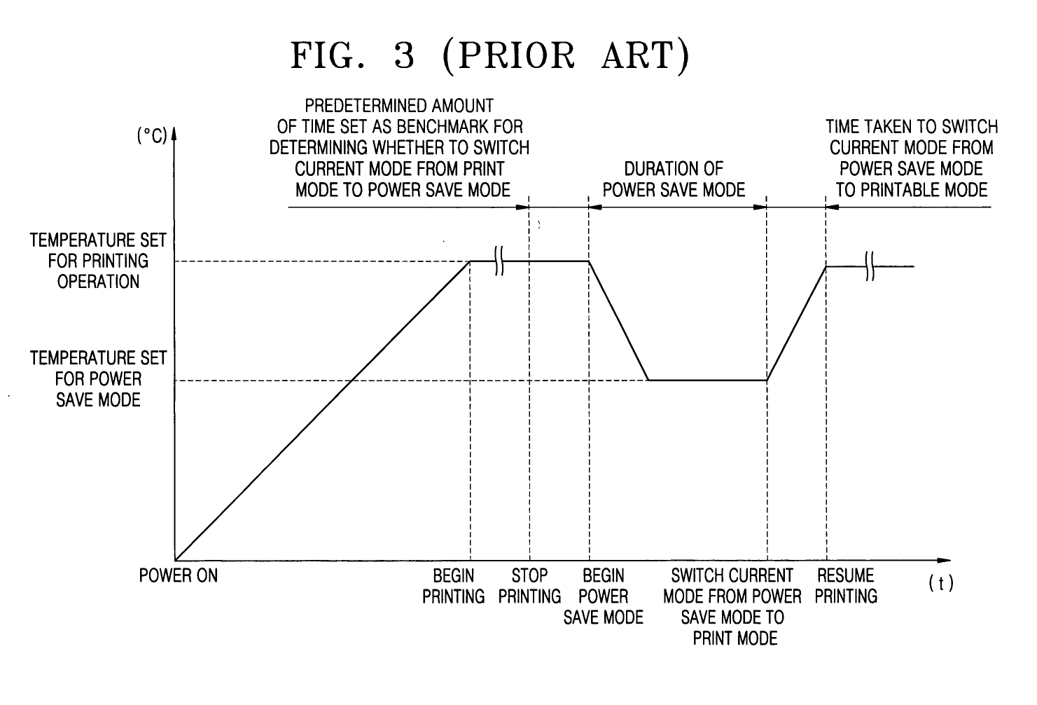

FIG. 3 is a graph illustrating a conventional power save mode of an electronic appliance;

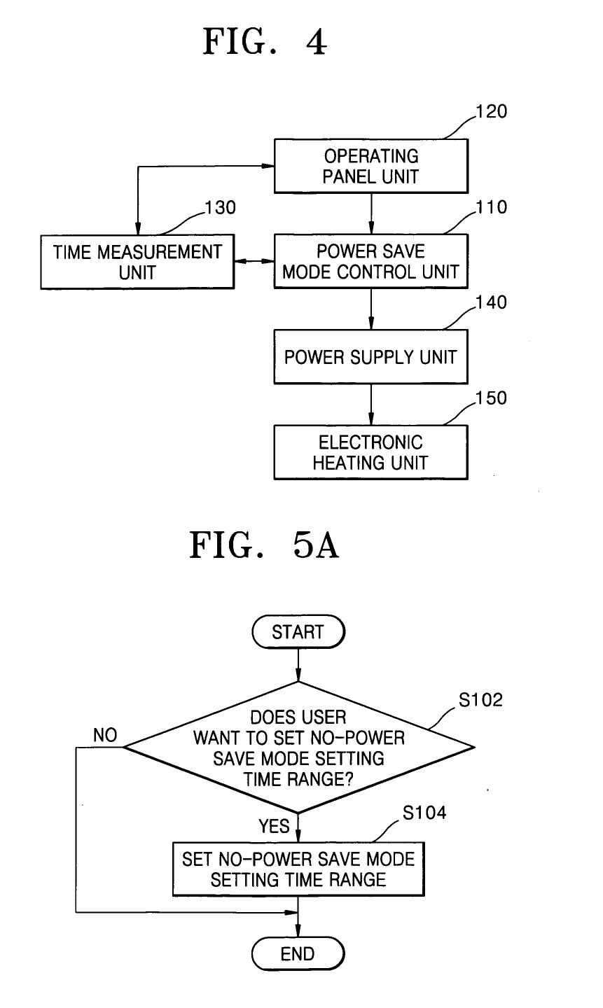

FIG. 4 is a block diagram illustrating an apparatus for controlling a power save mode of an electronic appliance according to an embodiment of the present invention; and

FIGS. 5A through 5C are flowcharts illustrating a method of controlling a power save mode of an electronic appliance according to an embodiment of the present invention.

Throughout the drawings, like reference numbers will be understood to refer to like elements, features and structures.

### DETAILED DESCRIPTION OF THE EXEMPLARY EMBODIMENTS

The present invention will now be described more fully with reference to the accompanying drawings, in which exemplary embodiments of the invention are shown. The matters defined in the following description such as a detailed construction and elements are provided to assist in a comprehensive understanding of the invention. Those of ordinary skill in the art will appreciate that various changes and modifications can be made to the embodiments described herein without departing form the spirit and scope of the invention. Also, descriptions of well-known functions or constructions are omitted for the sake of clarity

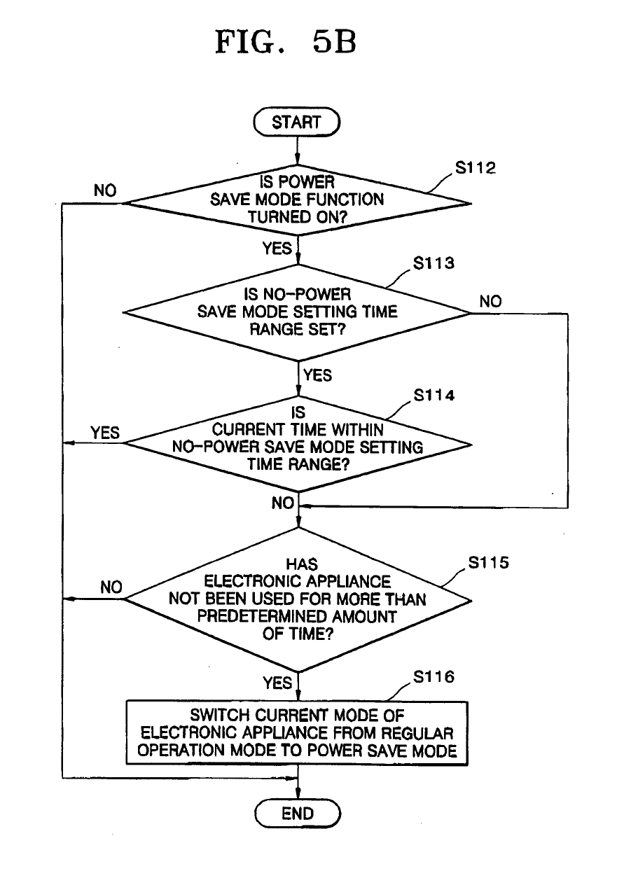

FIG. 4 is a block diagram illustrating an apparatus for controlling a power save mode of an electronic appliance according to an exemplary embodiment of the present invention. Referring to FIG. 4, the apparatus comprises a power save mode control unit 110, which prevents a power save mode from being set in a predetermined time range (hereinafter, referred to as ‘no-power save mode’ time range), for example, between 11 a.m. and 3 p.m., and an operating panel unit 120, which sets the ‘no-power save mode’ time range. The power save mode control unit 110 can set the power save mode outside the ‘no-power save mode’ time range, if conditions of the power save mode are met. In addition, the power save mode control unit 110 can also set a regular operation mode. The electronic appliance according to embodiments of the present invention can be used with a printer, a photocopier, a multifunctional device, an electronic oven, or the like.

The operating panel unit 120 may be located in a predetermined host terminal (such as a computer) that is connected to the electronic appliance and can communicate with the electronic appliance in a wired or wireless manner. For example, if the electronic appliance is a printer, the operating panel unit 120 may be located in the host terminal and use an application program or web browser to adjust various settings of the printer.

The ‘no-power save mode’ time range may be set as a default when manufacturing the electronic appliance.

The operating panel unit 120 may set the ‘no-power save mode’ time range in units of hours or minutes. A time measurement unit 130 provides time information to the operating panel unit 120 to allow the operating panel unit 120 to set the ‘no-power save mode’ time range. In addition, the time measurement unit 130 provides time information to the power save mode control unit 110 to allow the power save mode control unit 110 to prevent the power save mode from being set within the ‘no-power save mode’ time range.

A power supply unit 140 supplies power to an electrical heating unit 150, such as a heater or a lamp, which is disposed in the electronic appliance, under control of the power save mode control unit 110.

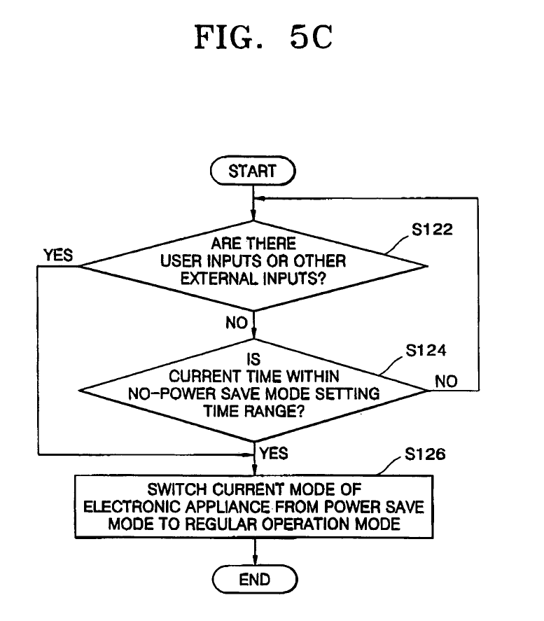

FIGS. 5A through 5C are flowcharts illustrating a method of controlling a power save mode of an electronic appliance according to an exemplary embodiment of the present invention. The method of controlling a power save mode of an electronic appliance according to the exemplary embodiment of the present invention involves operations S102 and S104 of FIG. 5A, in which a no-power save mode setting time range is set, operations S112 through S116 of FIG. 5B, in which a power save mode is prevented from being set in the no-power save mode setting time range, and a power save mode operation is performed at other times, and operations S122 through S126 of FIG. 5C, in which a current mode of an electronic appliance is switched from the power save mode to a regular operation mode.

Referring to FIG. 5A, the method of controlling a power save mode of an electronic appliance according to the exemplary embodiment of the present invention involves operation S102, in which it is determined whether to set a no-power save mode setting time range, and operation S104, in which the no-power save mode setting time range is set if it is determined to set the no-power save mode setting time range in operation S102.

Referring to FIG. 5B, the method of controlling a power save mode of an electronic appliance according to the exemplary embodiment of the present invention further involves operation S112, in which it is determined whether a power save mode function is turned on. If power save mode is on, it is determined whether the no-power save mode setting time range has been set (S113). If no-power save mode time range has been set, it is determined whether the current time is within the no-power save mode setting time range (S114). If the current time is not within the no-power save time range, it is determined whether the electronic appliance has not been used for more than a predetermined amount of time that has been set as a benchmark for determining whether to switch a current mode of the electronic appliance from a regular operation mode to a power save mode (S115). If the electronic appliance has not been used for mare than a predetermined amount of time, the current mode of the electronic appliance is switched from the regular operation mode to the power save mode (S116).

Referring to FIG. 5C, the method of controlling a power save mode of an electronic appliance according to the exemplary embodiment of the present invention involves operation S122, in which it is determined whether there are user inputs or other external inputs. If there are no user or external inputs to the electronic appliance, it is determined whether the current time is within the no-power save mode setting time range (S124). If the current time is within the no-power save time range, the current mode of the electronic appliance is switched from the power save mode to the regular operation mode (S126).

The operation of the apparatus for controlling a power save mode of an electronic appliance according to the exemplary embodiment of the present invention will now be described more fully with reference to FIGS. 4 and 5A through 5B.

If the electronic appliance is not in use, the power save mode control unit 110 of the electronic appliance measures how long the electronic appliance has not been in use and determines whether to switch a current mode of the electronic appliance from a regular operation mode to a power save mode based on the measured time.

If a power save mode function is set in the electronic appliance in operation S112, the power save mode control unit 110 determines whether a no-power save mode setting time range is set in operation S113. If the no-power save mode setting time range is set, the power save mode control unit 110 determines whether the current time is within the no-power save mode setting time range in operation S114. If the no-power save mode setting time range is yet to be set, the power save mode control unit 110 keeps checking whether the electronic appliance has not been used for more than a predetermined amount of time, which has been set as a benchmark for determining whether to switch the current mode of the electronic appliance from the regular operation mode to the power save mode, by referring to the time measurement unit 130 in operation S115.

If the current time is within the no-power save mode setting time range, the power save mode control unit 110 controls the power supply unit 140 so that the electronic appliance can be prevented from entering the power save mode. Otherwise, the power save mode control unit 110 performs operation S115.

If the electronic appliance has not been used for more than the predetermined amount of time, the power save mode control unit 110 switches the current mode of the electronic appliance from the regular operation mode to the power save mode in operation S116.

If the electronic appliance is currently in the power save mode, the power save mode control unit 110 checks whether there are user inputs or other external inputs (such as a print command) in operation S122. If there are such user inputs or other external inputs, the power save mode control unit 110 switches the current mode of the electronic appliance from the power save mode to the regular operation mode in operation S126. Otherwise, the power save mode control unit 110 checks whether the current time is within the no-power save mode setting time range in operation S124. If the current time is not within the no-power save mode setting time range, the power save mode control unit 110 maintains the power save mode. Otherwise, the power save mode control unit 110 switches the current mode of the electronic appliance from the power save mode to the regular operation mode so that the electronic appliance can readily respond to the user inputs or external inputs.

Accordingly, it is possible to respond to user requests without delay and minimize the inconvenience to the user during the time when the electronic appliance is frequently used, by preventing the electronic appliance from entering a power save mode. In addition, it is possible to conserve energy during the time when the electronic appliance is not in use by setting the power save mode in the electronic appliance.

While the present invention has been particularly shown and described with reference to exemplary embodiments thereof, it will be understood by those of ordinary skill in the art that various changes in form and details may be made therein without departing from the spirit and scope of the present invention as defined by the following claims.

1. An apparatus for controlling a power save mode of an electronic appliance that supports a power save mode function, the apparatus comprising:
a power save mode control unit, which prevents a power save mode from being set in the electronic appliance during a predetermined time range.

2. The apparatus of claim 1 further comprising:
a no-power save mode setting time range setting unit, which sets the predetermined time range so that the power save mode can be prevented from being set in the electronic appliance.

3. The apparatus of claim 2, wherein the no-power save mode setting time range setting unit is located in the operating panel equipment (OPE) of the electronic appliance, or in a predetermined host terminal which is connected to the electronic appliance so as to communicate with the electronic appliance in a wired or wireless manner.

4. The apparatus of claim 1, wherein the predetermined time range is set as a default when manufacturing the electronic appliance.

5. The apparatus of claim 1, wherein outside the predetermined time range, the power save mode control unit executes the power save mode according to conditions of the power save mode.

6. A method of controlling a power save mode of an electronic appliance that supports a power save mode function, the method comprising the operation of:
preventing a power save mode from being set in the electronic appliance during a predetermined time range.

7. The method of claim 6 further comprising the operation of:
setting the predetermined time range so that the power save mode can be prevented from being set in the electronic appliance.

8. The method of claim 7, wherein the operation of setting the predetermined time range is performed in the operating panel equipment (OPE) of the electronic appliance, or in a predetermined host terminal which is connected to the electronic appliance so as to communicate with the electronic appliance in a wired or wireless manner, and the predetermined host terminal is a computer.

9. The method of claim 6, wherein the operation of preventing the power save mode from being set in the electronic appliance is set as a default when manufacturing the electronic appliance.

10. The method of claim 6, wherein outside the predetermined time range, the power save mode is executed according to conditions of the power save mode.

11. The method of claim 10, wherein it is determined whether the conditions of the power save mode are met by determining whether the current time is within the predetermined time range.
